(19) United States
(12) Patent Application Publication
(10) Pub. No.: US 2022/0363283 A1
(43) Pub. Date: Nov. 17, 2022

(54) METHOD FOR ADAPTIVE LATERAL GUIDANCE OF A MOTOR VEHICLE AND LATERAL GUIDANCE ASSISTANT FOR A MOTOR VEHICLE

(71) Applicants: HYUNDAI MOTOR COMPANY, Seoul (KR); KIA CORPORATION, Seoul (KR)

(72) Inventor: Andy Prill, Heusenstamm (DE)

(73) Assignees: HYUNDAI MOTOR COMPANY, Seoul (KR); KIA CORPORATION, Seoul (KR)

(21) Appl. No.: 17/538,798

(22) Filed: Nov. 30, 2021

(30) Foreign Application Priority Data
May 12, 2021 (DE) 102021204858.7

(51) Int. Cl. B60W 50/08; B60W 50/10; B60W 40/08; B60W 10/20; G06V 20/59

(52) U.S. Cl. CPC B60W 50/085; B60W 50/10; B60W 40/08; B60W 10/20; G06V 20/597; B60W 2040/0818; B60W 2510/202; B60W 2540/18; B60W 2540/225; B60W 2540/229

(57) ABSTRACT

A method for adaptive lateral guidance of a motor vehicle method comprises: determining, by a driver state monitoring system of the motor vehicle, an attentiveness level of a driver steering the motor vehicle; and adapting, in case that the attentiveness level of the driver fulfills predefined criteria, a lateral steering configuration of a lateral guidance assistant of the motor vehicle by at least one of i) increasing a lateral steering tolerance for triggering a steering intervention of the lateral guidance assistant, and ii) suppressing a lateral steering intervention of the lateral guidance assistant.

### CROSS-REFERENCE TO RELATED APPLICATION

This application claims priority to and the benefit of German Patent Application No. 102021204858.7 filed in the German Patent and Trademark Office on May 12, 2021, the entire contents of which are incorporated herein by reference.

### TECHNICAL FIELD

The present disclosure pertains to a method for adaptive lateral guidance of a motor vehicle, a lateral guidance assistant for a motor vehicle, and a motor vehicle with such a lateral guidance assistant.

### BACKGROUND

Current motor vehicles are increasingly connected with sensors and telematics in order to implement advanced driver-assistance systems (ADAS) and/or autonomous driving functionalities. For example, cars may be provided with multiple sensors and various techniques for acquiring data from the environment, e.g. to provide accurate detection of other vehicles, pedestrians, obstacles, of the road ahead and/or behind and so on. Typical technologies that are utilized for this purpose include radar, laser, lidar, infrared, ultrasound, cameras, stereo vision, computer vision, odometry, accelerometers, gyroscopes, GPS, and so on. To produce a more consistent, accurate and useful view of the environment, a variety of such sensors may be provided on a car and the information from these sensors may be combined within a sensor system. Data collected with such a sensor system may be used to avoid contact between the vehicle and other objects, for example by warning a driver about an approaching object and/or by automatically steering the vehicle accordingly.

Various lateral guidance systems are provided for motor vehicles that are designed to help the driver keep the lateral position of the vehicle under control, e.g. to stay within a lane on a freeway. These systems are particularly designed to minimize human error related incidents by addressing distractions and drowsiness amongst others. Various different approaches are available on the market including: systems that warn the driver if the vehicle is leaving its lane with visual, audible, and/or vibration warnings (lane departure warning, LDW); systems that warn the driver and, with no response, automatically take steps to ensure the vehicle stays in its lane (lane keeping assist, LKA/LKS); and systems that assist in oversteering, keeping the vehicle centered in the lane, and asking the driver to take over in challenging situations (lane centering assist, LCA).

For example, document EP 2 253 499 B1 describes a driver assistance system for lateral guidance of the motor vehicle. In particular, the described system is a lane departure warning system, designed to generate a counter-steering moment in the event of a detected lane departure of the motor vehicle, which can be deactivated and/or overridden by a manual steering moment of the driver.

In general, there is a need to keep these systems from performing any unwanted lateral steering assistance in order to guarantee user satisfaction, comfort, and safety feeling and thereby increase user acceptance of these systems. It is particularly desired to avoid any automatic intervention of these systems in case that the driver is in fact active and focused and/or is performing a deliberate steering maneuver. The system should basically only intervene in cases of driver distraction and/or emergencies.

### SUMMARY

Hence, there is a need to find solutions for lateral guidance systems with improved consideration of driver distraction.

To this end, the present disclosure provides a method for adaptive lateral guidance, a lateral guidance assistant, and a motor vehicle.

According to one aspect of the disclosure, a method for adaptive lateral guidance of a motor vehicle comprises: determining, by a driver state monitoring system of the motor vehicle, an attentiveness level of a driver steering the motor vehicle; and adapting, in case that the attentiveness level of the driver fulfills predefined criteria, a lateral steering configuration of a lateral guidance assistant of the motor vehicle by at least one of i) increasing a lateral steering tolerance for triggering a steering intervention of the lateral guidance assistant, and/or ii) suppressing a lateral steering intervention of the lateral guidance assistant.

According to another aspect of the disclosure, a lateral guidance assistant comprises: a driver state monitoring system configured to determine an attentiveness level of a driver steering the motor vehicle; and a control device configured to adapt a lateral steering configuration of the lateral guidance assistant in case that the attentiveness level of the driver fulfills predefined criteria by at least one of i) increasing a lateral steering tolerance for triggering a steering intervention of the lateral guidance assistant, and/or ii) suppressing a lateral steering intervention of the lateral guidance assistant.

According to yet another aspect of the disclosure, a motor vehicle comprises a lateral guidance assistant according to the disclosure.

One idea of the present disclosure is to reduce undesired lateral steering events as they may be triggered by conventional lane keeping assistants and other such systems by using driver state monitoring to acquire additional information about the current alertness of the driver and to reconfigure the lateral guidance accordingly based on a more realistic estimation of the driver's true state. In this way, the assisted steering interventions can be appropriately adapted in case that the driver is in fact attentive. Thereby, any unnecessary and undesired intervention in the driving of the vehicle can be avoided, which could otherwise annoy and provoke the driver to manually override the lateral guidance. Hence, not only customer satisfaction can be increased but also safety may be improved on a general level.

Two possibilities are provided by the present disclosure that complement each other for all instances where the predefined criteria for the driver's attentiveness are fulfilled, i.e., where the alertness of the driver is affirmed. On the one hand, the lane edge tolerance of the system can be increased. On the other hand, assisted and/or automated steering functions of the lateral guidance system can be suppressed.

In the first instance, the vehicle may be allowed to depart further from an ideal and/or prescribed lane or driving path in case the driver is attentive than would be allowed in the respective system under default conditions. Or, in other words, the lane edge tolerance for steering intervention may become wider when the driver is attentive and may be reduced to normal/standard when the driver is distracted. This is based on the assumption that the driver is attentive and thus is likely to steer the vehicle intentionally along the respective track.

In the second case, the system may still assist the driver. However, any assisted driving command may be reduced in scope or amplitude (e.g. an automatic steering moment may be reduced that is acting on the driving wheel). In other instances, specific steering commands may be suppressed more or less entirely, i.e., the corresponding function may be overridden as long as the driver is considered to be attentive. Lateral steering interventions in that sense may not only comprise actual steering commands directly influencing the steering behavior of the vehicle but may also include steering recommendations and warnings to the driver. These may correspondingly get suppressed, for example, in case the driver is attentive.

It is understood that the terms “vehicle” or “vehicular” or other similar term as used herein are inclusive of motor vehicles in general. Such motor vehicles may include passenger automobiles including sports utility vehicles (SUV), buses, trucks, various commercial vehicles, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example a vehicle that is both gasoline-powered and electric-powered.

Advantageous embodiments and improvements upon the above embodiments and aspects of the present disclosure are found in the subordinate claims.

According to an embodiment of the disclosure, the driver state monitoring system may comprise a camera for determining the attentiveness level.

The camera may be part of a system that is already installed inside the vehicle to track the driver's face and/or eye movements, for example. However, the camera may also be provided for this particular purpose in the vicinity of the steering wheel, e.g. on a dashboard or a steering column, or anywhere else inside the passenger cabin.

According to an embodiment of the disclosure, the camera may be configured to track a face, a gaze, an eye, and/or an eyelid of the driver.

Depending on the specific configuration and requirements of the particular application, the camera may be a high-precision and/or high-performance system, e.g. a stereo IR camera. In other embodiments, a single IR camera may suffice. These and other camera systems may be used in various different implementations of the embodiment, e.g. to determine a gaze direction of the driver, i.e., to reconstruct where the driver is looking. The camera may employ facial recognition and face tracking, for example. Additionally, or alternatively, the eyes and/or the eyelids may be monitored, e.g. to detect if the driver is becoming sleepy.

According to an embodiment of the disclosure, the driver state monitoring system may be configured to determine a viewing direction of the driver to assess the attentiveness level of the driver.

The viewing direction of the driver may serve as one indicator for establishing whether the driver is attentive or distracted. For example, it may be determined if the driver is attentive and looking at the road ahead and/or on the dashboard or whether the driver is rather distracted and looking on a cell phone, to the left or right, or to the floor, for example.

According to an embodiment of the disclosure, the predefined criteria may define an attention border within a field of view of the driver. The driver may be considered attentive if the viewing direction of the driver remains within the attention border.

A viewing direction beyond the attention border may then be considered as an indicator of a distracted driver, at least if driver keeps looking beyond the border for some time, e.g. longer than a threshold of a few seconds.

According to an embodiment of the disclosure, a digression time interval may be defined during which the driver is still considered attentive after the viewing direction of the driver has left the attention border.

Hence, short glances beyond the attention region may be allowed as long as the driver's gaze returns back swiftly.

According to an embodiment of the disclosure, the control device may be configured to monitor a steering wheel angle and/or a steering wheel torque and to correlate these with the viewing direction of the driver to determine the attentiveness level of the driver.

This embodiment relies on the insight that the driver's viewing and/or gaze direction, as well as the driver's head orientation, turns when driving a curve, for example. In a curve, the driver's gaze direction may be in fact outside the attention border but may still not be considered an indicator for a distraction of the driver as long as the steering angle (drive direction) matches this gaze direction within a tolerance. Hence, the steering wheel angle may be used, for example, as an indicator that the driver is leaving the current trajectory and/or lane on purpose, e.g. because the driver wants to turn. In a similar vein, the steering wheel torque may indicate that the vehicle is intentionally moved across a traffic lane marking and that it is not drifting off its lane accidentally.

According to an embodiment of the disclosure, the driver state monitoring system may be configured to determine a cognitive distraction of the driver to assess the attentiveness level of the driver. The cognitive distraction may include acoustic noise inside the motor vehicle and/or an ongoing phone call of the driver, for example.

A cognitive distraction within the meaning of the present disclosure thus particularly comprises auditory input for the driver, which may distract him or her from driving. For example, cognitive distraction may increase during a phone call of the driver and/or during conversations with other occupants of the vehicle, in particular during mentally or emotionally challenging calls/discussions. In a similar vein, the driver may get distracted by loud or irritating noises within the vehicle, e.g. yelling, singing and/or playing children.

The driver state monitoring system may track gaze pattern or eye movements of the driver with a camera in order to determine that the driver is cognitively distracted to some degree. Additionally, or alternatively, the driver state monitoring system may also use one or several microphones within the vehicle to detect corresponding sound patterns. Moreover, the driver state monitoring system may assess whether a phone or video call is ongoing. To this end, the driver state monitoring system may be communicatively coupled to a telecommunication and/or multimedia system of the vehicle.

Depending on the degree of cognitive distraction, a corresponding attentiveness level may be determined by the driver state monitoring system. The control device may then adapt the lateral steering configuration of the lateral guidance assistant correspondingly. The adaptation may depend on certain parameters, e.g. the duration of a phone call or other acoustic distractions. For example, the system may decide that the driver is distracted if a phone call length surpasses a predefined threshold of some seconds/minutes.

The disclosure is explained in greater detail with reference to specific embodiments depicted in the drawings as appended.

### BRIEF DESCRIPTION OF THE DRAWINGS

The accompanying drawings are included to provide a further understanding of the present disclosure and are incorporated in and constitute a part of this specification. The drawings illustrate the embodiments of the present disclosure and together with the description serve to explain the principles of the disclosure. Other embodiments of the present disclosure and many of the intended advantages of the present disclosure should be readily appreciated as they become better understood by reference to the following detailed description. The elements of the drawings are not necessarily to scale relative to each other. In the figures, like reference numerals denote like or functionally like components, unless indicated otherwise.

FIG. 1 schematically depicts a lateral guidance assistant according to an embodiment of the disclosure.

FIG. 2 schematically shows the interior of a motor vehicle comprising the lateral guidance assistant of FIG. 1.

FIG. 3 shows a flow diagram of a method for adaptive lateral guidance using the lateral guidance assistant of FIG. 1.

FIGS. 4-7 show several driving examples using the lateral guidance assistant of FIG. 1.

Although specific embodiments are illustrated and described herein, it should be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein. Further, when a component, device, element, or the like of the present disclosure is described as having a purpose or performing an operation, function, or the like, the component, device, or element should be considered herein as being “configured to” meet that purpose or to perform that operation or function.

### DETAILED DESCRIPTION OF THE EMBODIMENTS

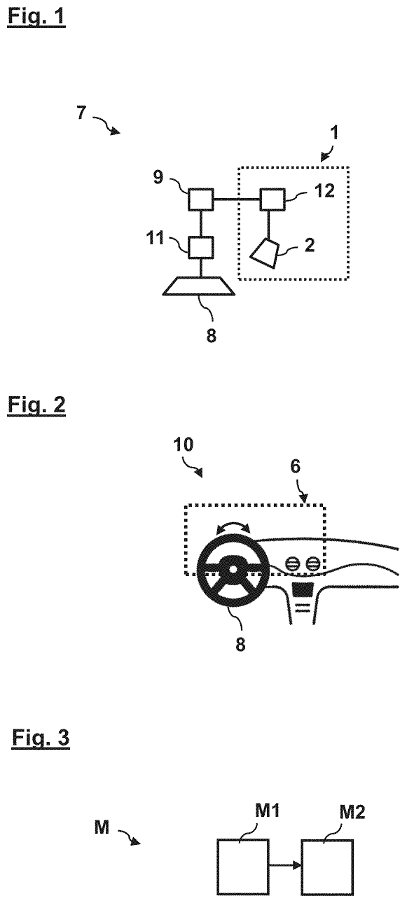

FIG. 1 schematically depicts a lateral guidance assistant 7 according to an embodiment of the disclosure, which may be integrated in a motor vehicle 10 as it is shown in FIG. 2 in an interior view.

The lateral guidance assistant 7 may provide features as they are known from common lane departure warning systems, lane keeping systems, and similar systems. Thus, the lateral guidance assistant 7 may be configured to assess a driving situation and—depending on the result—provide steering information, warning signals, steering recommendations, and/or steering commands to a driver of the vehicle 10 and/or directly to the vehicle 10 itself, in particular to a steering wheel 8 of the vehicle, e.g. via a steering actuator 11 coupled to the steering wheel 8.

For example, the lateral guidance assistant 7 may be configured to warn the driver when the vehicle 10 is leaving its lane with visual, audible, and/or vibration warnings. In another example, the lateral guidance assistant 7 may warn the driver and, with no response, automatically take steps to ensure the vehicle 10 stays in its lane. This may include, as mentioned above, actuating steering commands that are intended to move the vehicle 10 back into its ideal and/or desired position within its lane. In yet another example, the lateral guidance assistant 7 may assist the driver in oversteering, keeping the vehicle 10 centered in the lane, and asking the driver to take over in challenging situations. In yet another example, the lateral guidance assistant 7 may apply correction to the vehicle 10 in all instances where the vehicle 10 drifts beyond a solid lane marking.

The lateral guidance assistant 7 may comprise various sensors, in particular optical systems, as well as computers (i.e., with processors and memory) to determine the position of the vehicle 10 in the lane and that of other vehicles 10′ and obstacles in the vicinity of the vehicle 10. The lateral guidance assistant 7 may be triggered into action based on various criterias and parameters, which may be combined in a real-time multivariate approach for optimized performance. A lateral steering tolerance 3 may be defined based on a distance to a lane marking. To this end, the lateral guidance assistant 7 may also calculate the respective estimated time until the line crossing.

It is a known problem for at least some of the above conventional systems that drivers tend to ignore and/or override the respective system as they become annoyed by the system behavior in certain driving situations. One reason for this is that the system may issue an undesired lateral steering command even though the driver is attentive and fully in control of the vehicle's driving behavior. This may be due to the fact that some of the above systems do not monitor the driver's attentiveness but solely decide on basis of the current vehicle movements whether a warning or a counter-steering command is triggered.

To overcome the above problems, the lateral guidance assistant 7 of FIG. 1 incorporates a driver state monitoring system 1, which is configured to determine an attentiveness level of a driver steering the motor vehicle 10. The driver state monitoring system 1 may be part of an already existing system in the vehicle 10 or may be provided for this particular purpose. The driver state monitoring system 1 may comprise a driver state control 12 for controlling and reading out the camera 2. The driver state control 12 may be communicatively coupled to a central control device 9 of the lateral guidance assistant 7.

The driver state monitoring system 1 comprises a camera 2, e.g. a single or stereo IR camera, for determining the attentiveness level, which is configured to track a face, a gaze, an eye, and/or an eyelid of the driver. The acquired data may be used for identifying and tracking the gaze and/or the face of the driver, which in turn may be used to determine a viewing direction of the driver for assessing the attentiveness level of the driver.

Depending on the use case and/or the driving situation different approaches may be preferred. For example, one case may require high precision gaze tracking, while for another case face tracking may be more adequate, e.g. for low detection quality under certain conditions like direct sun light, etc. The system may then switch from gaze tracking to face tracking and vice versa depending on the driving situation and other factors like weather, environment, etc.

The reconstructed viewing direction of the driver may be used to establish if some predefined criteria indicating the attentiveness level of the driver are fulfilled or not. For example, an attention border 6 may be defined within a field of view of the driver as depicted in FIG. 2. The attention border 6 may define a box or rectangle or any other suitable two-dimensional shape within the field of view of the driver, e.g. about a steering wheel, dashboard, and/or front window of the vehicle 10. The attention border 6 may define a left border, a right border, a lower border, and an upper border for the viewing direction of the driver.

The driver may then be considered attentive if the viewing direction of the driver remains within the attention border 6 and inattentive if the driver looks outside of this region, at least for some time. Thus, a digression time interval may be defined during which the driver is still considered attentive after the viewing direction of the driver has left the attention border 6. For example, the digression time interval may be a few second, e.g. 2 s.

The control device 9 of the lateral guidance assistant 7 is further configured to monitor a steering wheel angle and/or a steering wheel torque and to correlate these with the viewing direction of the driver to determine the attentiveness level of the driver. The lateral guidance assistant 7 may additionally utilize further parameters that are similarly suited to ensure a high probability for correctly determining the driver's attention state.

The control device 9 of the lateral guidance assistant 7 is now configured to adapt a lateral steering configuration of the lateral guidance assistant 7 in case that the attentiveness level of the driver fulfills predefined criteria, i.e., in case the driver is considered to be attentive. The control device 9 may for example increase a lateral steering tolerance 3 for triggering a steering intervention of the lateral guidance assistant 7. Alternatively, or additionally, the control device 9 may suppress a lateral steering intervention of the lateral guidance assistant 7. Lateral steering interventions may particularly be automatic steering commands of the vehicle 10 but may also include steering recommendations and/or warning messages for the driver.

FIG. 3 shows a flow diagram of a corresponding method M for adaptive lateral guidance using the lateral guidance assistant 7 of FIG. 1. The method M comprises, under M1, determining the attentiveness level of the driver steering the motor vehicle 10. The method M further comprises, under M2, adapting, in case that the attentiveness level of the driver fulfills the predefined criteria, the lateral steering configuration of the lateral guidance assistant 7 by at least one of increasing a lateral steering tolerance 3 for triggering a steering intervention of the lateral guidance assistant 7 and/or suppressing a lateral steering intervention of the lateral guidance assistant 7.

FIGS. 4-7 show several driving examples using the lateral guidance assistant 7 of FIG. 1.

In the example of FIG. 4, the vehicle 10 is driving on a lane 5 along a road. The lateral guidance assistant 7 may define a lateral steering tolerance 3 between a left lateral steering edge 4a (discontinuous, broken, or dashed lane marking in this example, e.g. a center line separating the lane 5 from an oncoming lane) and a right lateral steering edge 4b (continuous or solid lane marking in this example, e.g. a road boundary). The lateral guidance assistant 7 may be generally configured to trigger appropriate (counter-steering) control (see the arrows in FIG. 4) and/or warning functions as soon as the vehicle 10 traverses and/or approaches the lateral steering edges 4a, 4b, i.e., when the vehicle 10 leaves or is about to leave the lateral steering tolerance 3.

The present system is now configured to adapt the lateral steering tolerance 3 depending on the determined attentiveness level of the driver. By default, the system may be turned on and running in a default mode and may only adapt its settings when it is able to positively verify that the driver is alert. The control device 9 of the assistant 7 may employ various additional parameters in order to assess the respective situation as comprehensively as possible, e.g. gaze angle, gaze duration, vehicle speed, steering wheel angle, threshold driver detection quality, and so on. These and other parameters may be evaluated in real-time.

In the example of FIG. 4, the driver may be distracted, or at least it may not be positively confirmed that the driver is attentive. The system may thus employ default settings for the lateral steering tolerance 3, which may be defined by the road markings.

In the example of FIG. 5, the lateral guidance assistant 7 may determine that the driver is attentive and may thus widen the default lateral steering tolerance 3 by a tolerance extension 3a, 3b. The selected extension 3a, 3b may depend on the particular driving situation, the type of road, and other factors. In the example of FIG. 5, crossing the right lateral steering edge 4b may imply driving off the road. Hence, the system may provide a smaller tolerance extension 3b on the right side of the road in order to prevent the vehicle 10 from driving into obstacles beside the road and/or because the road edge is not detected by the system.

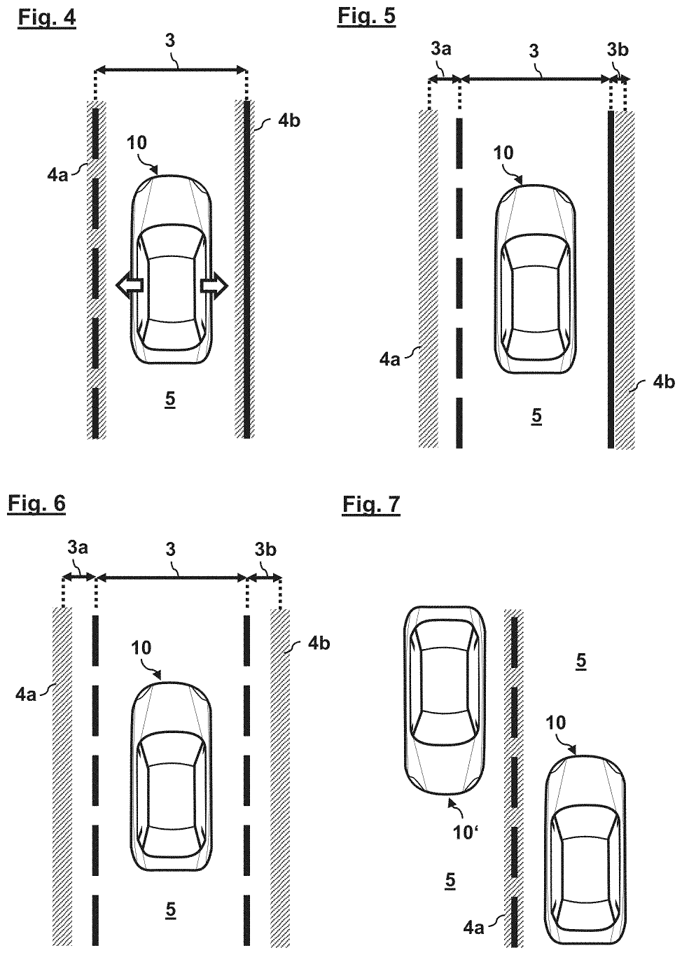

In other examples, the tolerance extensions 3a, 3b may be identical. FIG. 6 shows an example where the vehicle 10 drives on an inner lane of a freeway and may thus cross the lateral steering edges 4a, 4b on both sides. Hence, the lateral steering tolerance 3 is extended equally on both sides in case that the lateral guidance assistant 7 determines that the driver is alert.

Notwithstanding whether the driver is attentive or not, the lateral guidance assistant 7 may decide to switch back to the default settings for the lateral steering tolerance 3 under certain circumstances. FIG. 7 shows one example, where another vehicle 11′ approaches in an oncoming lane. In that case, the lateral guidance assistant 7 may act irrespective of the driver's attention state due to safety reasons. Another example could be an oncoming obstacle on the side of the road.

As described above, the lateral guidance assistant 7 may not only adapt the lateral steering tolerance but may also decide alternatively or additionally to suppress certain functions of the lateral guidance assistant 7 when the system determines that the driver is attentive. For example, the system may not trigger automatic steering commands that would actively interfere with the steering of the vehicle. In principle, the system may decide to suppress some or all of the steering interventions/warnings as long as the driver is determined to be attentive and/or no emergency situation is arising.

In the foregoing detailed description, various features are grouped together in one or more examples or examples with the purpose of streamlining the disclosure. It is to be understood that the above description is intended to be illustrative, and not restrictive. It is intended to cover all alternatives, modifications, and equivalents of the different features and embodiments. Many other examples should be apparent to one having ordinary skill in the art upon reviewing the above specification. The embodiments were chosen and described in order to explain the principles of the disclosure and its practical applications, to thereby enable others of ordinary skill in the art to utilize the disclosure and various embodiments with various modifications as are suited to the particular use contemplated.

### REFERENCE LIST

1 driver state monitoring system
2 camera
3 lateral steering tolerance
3a, 3b tolerance extension
4a, 4b lateral steering edge
5 lane
6 attention border
7 lateral guidance assistant
8 steering wheel
9 control device
10 motor vehicle
10′ other motor vehicle
11 steering actuator
12 driver state control
M method
M1, M2 method steps

1. Method for adaptive lateral guidance of a motor vehicle, the method comprising:
determining, by a driver state monitoring system of the motor vehicle, an attentiveness level of a driver steering the motor vehicle; and
adapting, in case that the attentiveness level of the driver fulfills predefined criteria, a lateral steering configuration of a lateral guidance assistant of the motor vehicle by at least one of or both of
increasing a lateral steering tolerance for triggering a steering intervention of the lateral guidance assistant, or
suppressing a lateral steering intervention of the lateral guidance assistant.

2. Method according to claim 1, wherein the attentiveness level is determined using a camera of the driver state monitoring system.

3. Method according to claim 2, wherein the camera tracks at least one of a face, a gaze, an eye and an eyelid of the driver.

4. Method according to claim 1, wherein a viewing direction of the driver is determined by the driver state monitoring system to assess the attentiveness level of the driver.

5. Method according to claim 4, wherein the predefined criteria define an attention border within a field of view of the driver, and wherein the driver is considered attentive if the viewing direction of the driver remains within the attention border.

6. Method according to claim 5, wherein a digression time interval is defined during which the driver is still considered attentive after the viewing direction of the driver has left the attention border.

7. Method according to claim 4, wherein at least one of a steering wheel angle and a steering wheel torque is monitored and correlated with the viewing direction of the driver to determine the attentiveness level of the driver.

8. Method according to claim 1, wherein a cognitive distraction of the driver is determined by the driver state monitoring system to assess the attentiveness level of the driver, the cognitive distraction including at least one of acoustic noise inside the motor vehicle and an ongoing phone call of the driver.

9. Lateral guidance assistant for a motor vehicle, comprising:
a driver state monitoring system configured to determine an attentiveness level of a driver steering the motor vehicle; and
a control device configured to adapt a lateral steering configuration of the lateral guidance assistant in case that the attentiveness level of the driver fulfills predefined criteria by at least one of or both of
increasing a lateral steering tolerance for triggering a steering intervention of the lateral guidance assistant, or
suppressing a lateral steering intervention of the lateral guidance assistant.

10. Lateral guidance assistant according to claim 9, wherein the driver state monitoring system comprises a camera for determining the attentiveness level.

11. Lateral guidance assistant according to claim 10, wherein the camera is configured to track at least one of a face, a gaze, an eye and an eyelid of the driver.

12. Lateral guidance assistant according to claim 9, wherein the driver state monitoring system is configured to determine a viewing direction of the driver to assess the attentiveness level of the driver.

13. Lateral guidance assistant according to claim 12, wherein the predefined criteria define an attention border within a field of view of the driver, and wherein the driver is considered attentive if the viewing direction of the driver remains within the attention border.

14. Lateral guidance assistant according to claim 13, wherein a digression time interval is defined during which the driver is still considered attentive after the viewing direction of the driver has left the attention border.

15. Lateral guidance assistant according to claim 12, wherein the control device is configured to monitor at least one of a steering wheel angle and a steering wheel torque and to correlate it with the viewing direction of the driver to determine the attentiveness level of the driver.

16. Lateral guidance assistant according to claim 9, wherein the driver state monitoring system is configured to determine a cognitive distraction of the driver to assess the attentiveness level of the driver, the cognitive distraction including at least one of acoustic noise inside the motor vehicle and an ongoing phone call of the driver.

17. Motor vehicle with a lateral guidance assistant according to claim 9.
